(19) United States
(12) Patent Application Publication
(10) Pub. No.: US 2026/0089786 A1
(43) Pub. Date: Mar. 26, 2026

(54) TERMINAL APPARATUS

(71) Applicant: SHARP KABUSHIKI KAISHA, Sakai City, Osaka (JP)

(72) Inventors: Masaki IZUMI, Sakai City, Osaka (JP); YASUO SUGAWARA, Sakai City, Osaka (JP); SHUICHIRO CHIBA, Sakai City, Osaka (JP)

(21) Appl. No.: 19/143,147

(22) PCT Filed: Oct. 31, 2023
(86) PCT No.: PCT/JP2023/039270

§ 371 Date: Jun. 25, 2025

(30) Foreign Application Priority Data
Apr. 7, 2023 (JP) 2023-062874

(51) Int. Cl. H04W 76/18; H04W 4/40

(52) U.S. Cl. CPC H04W 76/18; H04W 4/40

(57) ABSTRACT

In a case that a terminal apparatus does not include a UICC and is not authorized to use A2X communication, the terminal apparatus transmits a direct link establishment reject message. In a case that a validity timer expires, the terminal apparatus stops the A2X communication via PC5.

### TECHNICAL FIELD

The present example relates to a terminal apparatus. This application claims priority to JP 2023-062874 filed on Apr. 7, 2023, the contents of which are incorporated herein by reference.

### BACKGROUND ART

In the 3rd Generation Partnership Project (3GPP: trade name), system architecture of a 5G System (5GS), which is a fifth generation (5G) mobile communication system, has been studied, and discussions are underway to support new procedures and new functions (see NPLs 1to 4). In recent years, discussions on a function for implementing Aircraft-to-anything (A2X) services have been actively carried out.

### CITATION LIST

### Non Patent Literature

NPL 1: 3GPP TS 24.501 V18.2.0 (2023-03); 3rd Generation Partnership Project; Technical Specification Group Core Network and Terminals; Non-Access-Stratum (NAS) protocol for 5G System (5GS); Stage 3 (Release 18)

NPL 2: 3GPP TS 23.256 V17.5.0 (2022-12); 3rd Generation Partnership Project; Technical Specification Group Services and System Aspects; Support of Uncrewed Aerial Systems (UAS) connectivity, identification and tracking; Stage 2 (Release 17)

NPL 3: 3GPP TS 23.285 V17.1.0 (2022-06); 3rd Generation Partnership Project; Technical Specification Group Services and System Aspects; Architecture enhancements for V2X services (Release 17)

NPL 4: 3GPP TS 24.587 V18.0.0 (2022-12); 3rd Generation Partnership Project; Technical Specification Group Core Network and Terminals; Vehicle-to-Everything (V2X) services in 5G System (5GS); Stage 3 (Release 18)

### SUMMARY OF INVENTION

### Technical Problem

For the 5G System (5GS), a 5G Core Network (5GCN) which is a new core network has been studied for the purpose of providing various services. Note that, for the 5GS, a function for implementing Aircraft-to-anything (A2X) services in which communication between UAVs is provided has also been studied.

Specifically, behaviors of the UAV not including a Universal Integrated Circuit Card (UICC) and information configured by radio parameters have been studied. Meanwhile, specific behaviors in A2X communication between UAVs not including a UICC and specific behaviors of the UAV for radio parameters are not clarified.

The present example has been made in light of the above circumstances. In the present example, a procedure for establishing a communication path for A2X communication between UAVs not including a UICC is clarified. Behaviors of the UAV for radio parameters are clarified.

### Solution to Problem

A terminal apparatus according to the present example is an Uncrewed Aerial Vehicle (UAV). The terminal apparatus includes a controller and a storage unit. The storage unit includes a radio parameter. The radio parameter includes a geographical area, an altitude range, and a validity timer. In a case that the controller performs Aircraft-to-anything (A2X) communication via PC5 by using the radio parameter associated with the validity timer, and the validity timer expires, the controller stops the A2X communication via PC5, and the controller performs a procedure for starting the A2X communication via Uu.

### Advantageous Effects of Invention

According to the present example, the procedure for establishing a communication path for A2X communication between UAVs not including a UICC can be clarified. The behaviors of the UAV for radio parameters can be clarified.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMF/SMF/UPF) in the 5GS.

FIG. 6 is a diagram illustrating a registration procedure.

FIG. 7 is a diagram illustrating a PDU session establishment procedure.

FIG. 8 is a diagram illustrating a network-requested UE policy management procedure.

FIG. 9 is a diagram illustrating a UE-requested A2X policy provisioning procedure.

FIG. 10 is a diagram illustrating a PC5 unicast link establishment procedure.

FIG. 11 is a diagram illustrating a first embodiment.

### DESCRIPTION OF EMBODIMENTS

Preferred embodiments for carrying out the present example will be described below with reference to the drawings. Note that an embodiment of a mobile communication system to which the present example is applied will be described as an example in the present embodiment.

### 1. Overview of System

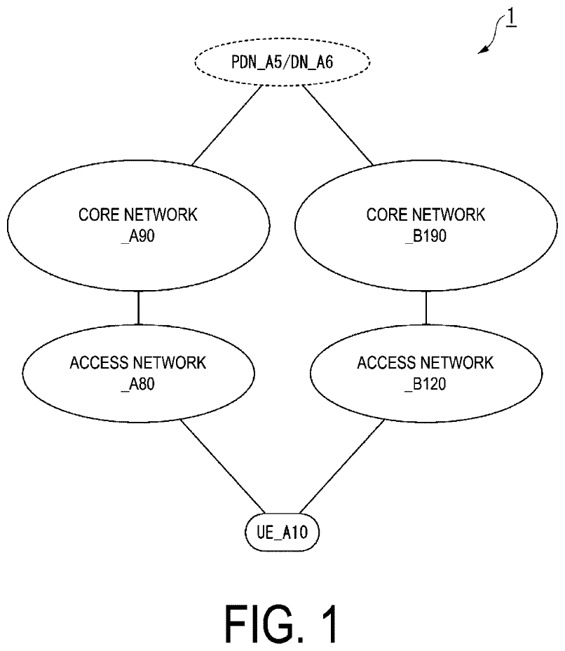

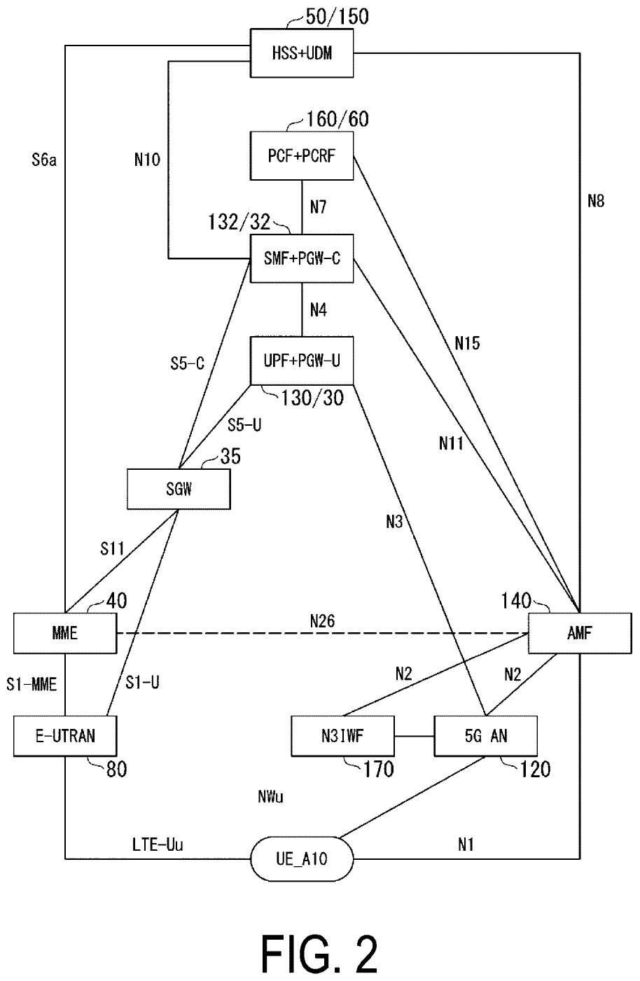

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network_A 80, a core network_A 90, a Packet Data Network (PDN)_A 5, an access network_B 120, a core network_B 190, and a Data Network (DN)_A 6.

In the following description, the reference numerals of these apparatuses and functions may be omitted, as in a UE, an access network_A, a core network_A, a PDN, an access network_B, a core network_B, a DN, and the like.

FIG. 2 illustrates apparatuses and functions such as the UE_A10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes an access network A and a core network_A and may further include a UE and/or a PDN. A 5G System (5GS) that is a 5G system includes UE, an access network_B, and a core network_B and may further include a DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as user equipment or a terminal apparatus.

The access network_A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In a case that there are multiple eNBs, the eNBs are connected to each other via, for example, an X2 interface. One or more access points are deployed on the wireless LAN access network.

The access network_B corresponds to a 5G access network (5G AN). The 5G AN includes an NG Radio Access Network (NG-RAN) and/or a non-3GPP access network. One or multiple NR NodeBs (gNBs) 122 are deployed on the NG-RAN. Note that in the following description, the symbol for the gNB 122 may be omitted as a gNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In a case that there are multiple gNBs, the gNBs are connected to each other via, for example, an Xn interface.

A non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

In the following description, the E-UTRAN and the NG-RAN may be referred to as 3GPP access. The wireless LAN access network and the non-3GPP AN may be referred to as non-3GPP access. Nodes deployed on the access network_B may also be collectively referred to as NG-RAN nodes.

In the following description, the access network_A, and/or the access network_B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

The core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In the following description, the core network_A, and/or the core network B, an apparatus included in the core network_A, and/or an apparatus included in the core network B may be referred to as a core network, a core network apparatus, or an intra-core network apparatus.

The core network (the core network_A and/or the core network_B) may refer to an IP mobile communication network operated by a mobile communication (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

Although FIG. 1 illustrates a case that the PDN and the DN are the same, the PDN and the DN may be different. The PDN may be a Data Network (DN) that provides communication services to the UE. Note that the DN may be configured as a packet data service network or may be configured for each service. Furthermore, the PDN may include a connected communication terminal. Thus, “to be connected to the PDN” may mean “to be connected to a communication terminal and a server apparatus deployed in the PDN”. Furthermore, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network_A, the core network_A, the PDN, the access network_B, the core network_B, and the DN, and/or one or more apparatuses included in these transmit and/or receive a message and/or perform a procedure”.

The UE can be connected to the access network. The UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included.

Non-IP communication refers to data communication performed without using IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

Apparatuses which are not illustrated in FIG. 2 may be included in the access network_A, the core network_A, the access network_B, the core network_B, the PDN_A, and the DN A. For example, the core network_A and/or the core network_B may include an Authentication Server Function (AUSF) and an Authentication, authorization, and accounting (AAA) server (AAA-S).

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server may not be included in the core network_A and/or the core network_B and may be included in the PLMN. In other words, the AAA server may be a core network apparatus or may be an apparatus outside the core network. For example, the AAA server may be a server apparatus within the PLMN managed by a 3rd party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

A UPF A_235 is connected to the DN, the SMF, other UPFs and the access network. The UPF_A 235 may play roles of an anchor to intra-RAT mobility or inter-RAT mobility, Packet routing & forwarding, an Uplink Classifier (UL CL) function to support routing of multiple traffic flows for one DN, a Branching point function to support a multi-homed PDU session, QoS processing for a user plane, verification of uplink traffic, buffering of downlink packets, a function of triggering Downlink Data Notification, and the like. Furthermore, the UPF_A 235 may be a relay apparatus that transfers the user data as a gateway between the DN and the core network B 190. Note that the UPF_A 235 may serve as a gateway for IP communication and/or non-IP communication. Furthermore, the UPF_A 235 may have a function of transferring IP communication or a function to perform conversion between non-IP communication and IP communication. Furthermore, the multiple gateways deployed may serve as gateways for connecting the core network_B 190 with a single DN. Note that the UPF_A 235 may have connectivity with another NF or may be connected to each apparatus via another NF.

Note that, a UPF_C 239 (also referred to as a branching point or an uplink classifier), which is a UPF different from the UPF_A 235, may be present as an apparatus or NF between the UPF A 235 and the access network. With the UPF_C 239 present, the PDU session between the UE and the DN is established via the access network, the UPF_C 239, and the UPF_A 235. The UPF 130 may be an apparatus similar to the UPF_A 235. Note that the UPF 130 and the UPF A 235 may be described with the symbols thereof omitted, like the UPF.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. Each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. Each storage unit can store identification information, control information, flags, parameters, and the like included in a control message transmitted and/or received in various communication procedures to be described later. Each storage unit may store these pieces of information for each UE. In a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

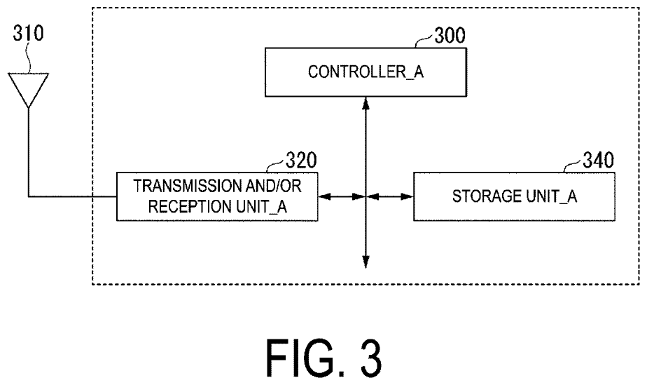

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller_A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. The UE can communicate with the base station apparatus (gNB) within the 5G AN with the use of the transmission and/or reception unit_A 320. The UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE.

### 2.2. Apparatus Configuration of gNB

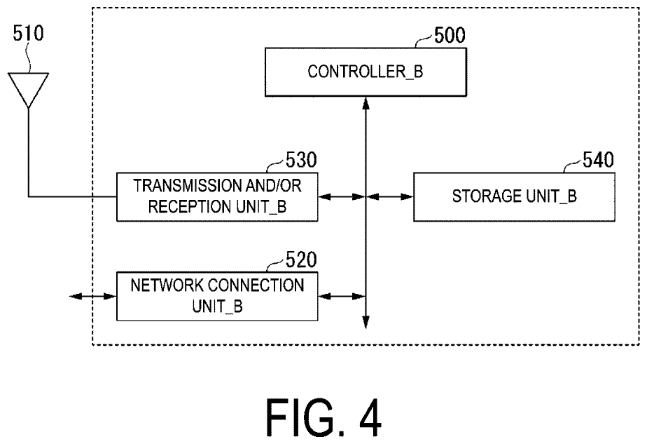

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit_B 540 are connected via a bus. The transmission and/or reception unit_B 530 is connected to the antenna 510.

The controller_B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. The gNB can communicate with the UE with the use of the transmission and/or reception unit_B 530.

The storage unit_B 540 is a function unit that stores programs, user data, control information, and the like necessary for each operation of the gNB.

### 2.3. Apparatus Configuration of ANF

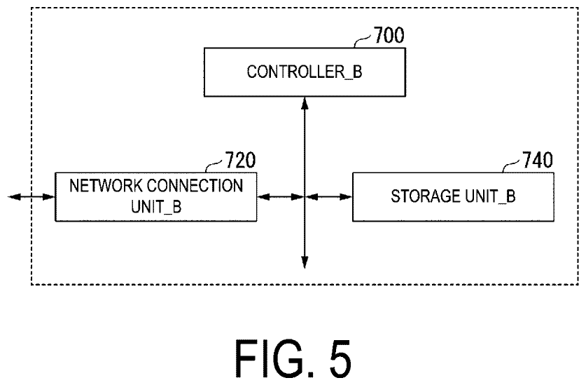

Next, an apparatus configuration example of the AMF will be described with reference to FIG. 5. The AMF includes a controller_B 700, a network connection unit_B 720, and a storage unit B 740. The controller_B 700, the network connection unit_B 720, and the storage unit_B 740 are connected via a bus. The AMF may be a node that handles a control plane.

The controller B 700 is a function unit that controls overall operations and functions of the AMF. The controller_B 700 reads and performs various programs stored in the storage unit B 740 as necessary, and thereby implements various types of processing in the AMF.

The network connection unit_B 720 is a function unit for the AMF to connect to the base station apparatus (gNB) within the 5G AN, and/or the SMF, and/or the PCF, and/or the UDM, and/or an SCEF. In other words, with the use of the network connection unit_B 720, the AMF can transmit and/or receive user data and/or control information to and/or from the base station apparatus (gNB) in the 5G AN, and/or the SMF, and/or the PCF, and/or the UDM, and/or the SCEF.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. The AMF can transmit and/or receive a NAS message to and/or from the UE over the N1 interface with the use of the network connection unit_A 620. However, the N1 interface is a logical interface, and thus communication between the UE and the AMF is actually performed over the 5G AN. In a case that the AMF supports an N26 interface, the AMF can communicate with the MME over the N26 interface with the use of the network connection unit_A 620.

The storage unit_B 740 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

Furthermore, 5GMM-DEREGISTERED may be a state in which each apparatus does not establish the 5GMM context, may be a state in which the location information of the UE_A 10 is not known to the network, or may be a state in which the network is unable to reach the UE_A 10. Note that, in a case that each apparatus is in 5GMM-DEREGISTERED, the UE_A 10 may initiate the registration procedure, or may perform the registration procedure to thereby establish the 5GMM context.

In connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In the CM-IDLE state, the UE has neither connection of the N2 interface (N2 connection) nor connection of the N3 interface (N3 connection). On the other hand, in the CM-CONNECTED state, the UE has NAS signaling connection established with the AMF via the N1 interface. In the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access).

Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). Furthermore, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). Furthermore, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

One or multiple AMFs may be deployed within the core network_B. The AMF may be a Network Function (NF) that manages one or more Network Slice Instances (NSIs). The AMF may be a common CP function (Common Control Plane Network Function (CPNF) (CCNF)) shared among multiple NSIs.

Note that, in a case that the UE connects to the 5GS over non-3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit B 740. The controller_B 700, the network connection unit_B 720, and the storage unit_B 740 are connected via a bus. The SMF may be a node that handles the control plane.

The controller B 700 is a function unit that controls overall operations and functions of the SMF. The controller_B 700 reads and performs various programs stored in the storage unit B 740 as necessary, and thereby implements various types of processing in the SMF.

The network connection unit B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

To provide detailed description with reference to FIG. 2, by using of the network connection unit_A 620, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit B 740. The controller_B 700, the network connection unit_B 720, and the storage unit_B 740 are connected via a bus. The UPF may be a node that handles the control plane.

The controller B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit_A 620, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be interconnected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QOS) processing function for the user plane, a function of verifying uplink traffic, a function of triggering buffering of downlink packets and Downlink Data Notification, and the like.

The UPF may be a gateway for IP communication and/or non-IP communication. The UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an S5 interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

Furthermore, a control plane refers to a control message that is transmitted and/or received in order to perform communication control of the UE or the like. The control plane may be transmitted and/or received using Non-Access-Stratum (NAS) signaling connection between the UE and the MME. Furthermore, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.6. Description of Other Apparatuses and/or Functions

Next, other apparatuses and/or functions will be described.

First, the terminal apparatus may be a Mobile Equipment (ME). The terminal apparatus may or may not include a Universal Integrated Circuit Card (UICC) and/or a Universal Subscriber Identity Module (USIM).

Note that the UE described in this specification may be interpreted as a terminal apparatus. The terminal apparatus may be interpreted as a UE or a UAV.

In this specification, terminal apparatus No#1 and terminal apparatus #2 may be present as the terminal apparatuses.

Next, an Uncrewed Aerial Vehicle (UAV) may be a flying drone. The UAV may be associated with a UAV controller. Further, the UAV may be associated with the UAV controller and managed by a core network apparatus and/or a UTM. Further, in a case that the UAV is managed in association with the UAV controller, the UAV may be managed by the core network apparatus and/or the UTM as a UAS. The UAV may have its own information (identification information, IP address, location information, etc.) managed by the core network apparatus and/or the UTM. The UAV may be a UE.

Next, the UAV controller is a controller for operating the UAV. The UAV controller may be associated with the UAV. Further, the UAV controller may be associated with the UAV and managed by the core network apparatus and/or the UTM. Further, in a case that the UAV controller is managed in association with the UAV, the UAV controller may be managed by the core network apparatus and/or the UTM as a UAS. The UAV controller may have its own information (identification information, IP address, location information, etc.) managed by the core network apparatus and/or the UTM. The UAV controller may be a UE. Note that the UAV controller may be expressed as a UAC or a UAV-C. The UAV-C may be a UE.

Next, the Uncrewed Aerial System (UAS) may include a UAV and a UAV controller. The UAS may be managed by the core network apparatus and/or the UTM. The UAS may include one UAV and one UAV controller.

Furthermore, the Uncrewed Aerial System (UAS) may include a UAV and related functions. Here, the related functions may include a command and control (C2) link.

Furthermore, the C2 link may be a link between the UAV and a control apparatus, or a link between the UAV and a network. Further, the C2 link may be a link for remote identification.

Next, the network refers to at least some of the access network_B, the core network_B, and the DN. One or multiple apparatuses included in at least a part of the access network_B, the core network_B, and the DN may be referred to as a network or a network apparatus.

In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

Furthermore, the network may indicate a Public Land Mobile Network (PLMN), or may indicate a Non-Public Network (NPN).

Note that the network may be referred to as an NW.

Next, the Public land mobile network (PLMN) is a communication network that provides mobile radio communication services. The PLMN is a network managed by an operator who is a network operator, and the operator can be identified by a PLMN ID. A PLMN that matches a Mobile Network Code (MNC) and a Mobile Country Code (MCC) of an International Mobile Subscription Identity (IMSI) of the UE may be a Home PLMN (HPLMN). Furthermore, the UE may store, in the USIM, an Equivalent PLMN list for identifying one or multiple Equivalent PLMNs (EPLMNs). A PLMN different from the HPLMN and/or the EPLMN may be a VPLMN (Visited PLMN). A PLMN with which the UE has successfully registered may be a Registered PLMN (RPLMN).

Next, PLMN selection may be a procedure for the UE to select a PLMN.

Next, a Policy Control Function (PCF) may be an NF having a function of determining a policy for controlling a behavior of a network.

Next, the Session Management (SM) message may be a NAS message used in a procedure for SM. The SM message may be referred to as a Non-Access-Stratum (NAS) SM message. The SM message may be a control message transmitted and/or received between the UE A 10 and an SMF A 230 via an AMF A 240.

Next, an SM procedure may be a procedure for SM.

Next, the Mobility management (MM) message may be a NAS message used in a procedure for MM. The MM message may be a control message transmitted and/or received between the UE A 10 and the AMF_A 240. Note that the MM message may be referred to as a NAS MM message.

Next, an MM procedure may be a procedure for MM.

Next, a 5G System (5GS) service may be a connection service provided using the core network B 190.

Next, a non 5GS service may be a service other than the 5GS service.

Next, although a Protocol Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using the PDU session. Note that each apparatus (the UE, and/or the access network apparatus, and/or the core network apparatus) may associate one or multiple pieces of identification information with a PDU session for management. Note that these pieces of identification information may include one or multiple of a DNN, a QoS rule, a PDU session type, application identification information, NSI identification information, access network identification information, and an SSC mode, and may further include other pieces of information. Furthermore, in a case that multiple PDU sessions are established, pieces of identification information associated with the PDU sessions may have the same or different details.

Next, a Protocol Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Alternatively, Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPV6.

Next, the Data Network Name (DNN) may be identification information for identifying the core network and/or an external network such as the DN. Further, the DNN can also be used as information for selecting a gateway such as a PGW/UPF connecting the core network B 190.

Next, PC5 is a reference point. PC5 may be an inter-UE reference point supporting ProSe, or an inter-UE reference point supporting UAS, or an inter-UE reference point supporting A2X, or an inter-UE reference point, or an inter-terminal apparatus reference point.

Next, a PC5 path may be a communication path over PC5. The PC5 path may be an inter-UE communication path supporting ProSe, or an inter-UE communication path supporting UAS, or an inter-UE communication path supporting A2X, or an inter-UE communication path, or an inter-terminal apparatus communication path. Note that the PC5 path may be referred to as a PC5 interface.

Next, Uu may be a radio interface. Uu may be a radio interface between the 5G AN and the UE.

Next, a Uu path may be a communication path on Uu. The Uu path may be a communication path between the 5G AN and the UE. Note that the Uu path may be referred to as a Uu interface.

Next, an initiating UE may be a UE. The initiating UE may be a UE that transmits and/or receives a message to and/or from a target UE.

Next, the target UE may be a UE. The target UE may be a UE that transmits and/or receives a message to and/or from the initiating UE.

Next, Aircraft-to-anything (A2X) communication is communication for supporting A2X services utilizing the PC5 reference point. Here, the A2X services may be implemented by various types of A2X applications, such as Broadcast Remote ID (BRID) and Detect And Avoid (DAA). The A2X communication may be communication over PC5.

Next, the A2X service is a data service provided to the A2X application and the A2X application server. The A2X service may belong to one A2X service type. The A2X service can be associated with one or more A2X applications, and the A2X application can be associated with one or more A2X services.

Next, Detect And Avoid (DAA) is a capability of taking an appropriate action by visually recognizing, or sensing, or detecting colliding traffic and other hazards.

Next, Direct Detect And Avoid (DDAA) is DAA utilizing communication on the PC5 reference point.

Next, the terminal apparatus being “not served by E-UTRA” and/or “not served by NR” may mean the terminal apparatus not being able to communicate with the network, or may mean the terminal apparatus being able to use communication over PC5 only.

Next, the terminal apparatus being “served by E-UTRA” and/or “served by NR” may mean the terminal apparatus being able to communicate with the network, or may mean the terminal apparatus being able to use communication over PC5 and/or communication on Uu.

The terminal apparatus being “not served by E-UTRA” may mean the terminal apparatus not being able to communicate with the base station or the network using E-TURA technology.

The terminal apparatus being “not served by NR” may mean the terminal apparatus not being able to communicate with the base station or the network using NR technology.

### 2.7. Description of Identification Information according to Present Embodiment

Next, the identification information transmitted and/or received, and/or stored, and/or managed by each apparatus in the present embodiment will be described.

First, first identification information may be information indicating whether the terminal apparatus is authorized to use the A2X communication via PC5 in a case that the terminal apparatus is “not served by E-UTRA” and/or “not served by NR”. The first identification information may be information indicating that the terminal apparatus is authorized or not authorized to use the A2X communication via PC5 in a case that the terminal apparatus is “not served by E-UTRA” and/or “not served by NR”. The first identification information may be included in the 20th identification information.

The first identification information may be information indicating whether terminal apparatus #1 is authorized to use the A2X communication via PC5 in a case that terminal apparatus #1 is “not served by E-UTRA” and/or “not served by NR”. The first identification information may be information indicating that terminal apparatus #1 is authorized or not authorized to use the A2X communication via PC5 in a case that terminal apparatus #1 is “not served by E-UTRA” and/or “not served by NR”. The first identification information may be included in the 20th identification information.

Next, second identification information may be information indicating whether the terminal apparatus includes a UICC. The second identification information may be information indicating that the terminal apparatus includes or does not include a UICC. The second identification information may be included in the 20th identification information.

The second identification information may be information indicating whether terminal apparatus #1 includes a UICC. The second identification information may be information indicating that terminal apparatus #1 includes or does not include a UICC. The second identification information may be included in the 20th identification information.

Next, 10th identification information is a cause value or a reject cause value. The 10th identification information is a cause value or a reject cause value indicating #1 (direct communication to the target UE not allowed). The 10th identification information may be a cause value indicating that direct communication with the terminal apparatus is not allowed.

The 10th identification information may be a cause value indicating that direct communication with terminal apparatus #2 is not allowed.

The 10th identification information may be #3 (conflict of layer-2 ID for unicast communication is detected), may be #5 (lack of resources for PC5 unicast link), or may be #111 (protocol error, unspecified).

Next, 11th identification information is a cause value or a reject cause value. The 11th identification information may be a cause value indicating that the terminal apparatus does not include a UICC. The 11th identification information may be a cause value indicating that the terminal apparatus is not authorized to use the A2X communication via PC5 in a case that the terminal apparatus is “not served by E-UTRA”and/or “not served by NR”.

The 11th identification information may be a cause value indicating that direct communication with the terminal apparatus is not allowed because (a) the terminal apparatus does not include a UICC and/or because (b) the terminal apparatus is not authorized to use the A2X communication via PC5 in a case that the terminal apparatus is “not served by E-UTRA” and/or “not served by NR”.

The 11th identification information may be a cause value indicating that terminal apparatus #2 does not include a UICC. The 11th identification information may be a cause value indicating that terminal apparatus #2 is not authorized to use the A2X communication via PC5 in a case that terminal apparatus #2 is “not served by E-UTRA”and/or “not served by NR”.

The 11th identification information may be a cause value indicating that direct communication with terminal apparatus #2 is not allowed because (a) terminal apparatus #2 does not include a UICC and/or because (b) terminal apparatus #2 is not authorized to use the A2X communication via PC5 in a case that terminal apparatus #2 is “not served by E-UTRA” and/or “not served by NR”.

Next, 12th identification information may be information indicating whether the terminal apparatus is authorized to use the A2X communication via PC5 in a case that the terminal apparatus is “not served by E-UTRA” and/or “not served by NR”. The 12th identification information may be information indicating that the terminal apparatus is authorized or not authorized to use the A2X communication via PC5 in a case that the terminal apparatus is “not served by E-UTRA” and/or “not served by NR”. The 12th identification information may be included in the 20th identification information.

The 12th identification information may be information indicating whether terminal apparatus #2 is authorized to use the A2X communication via PC5 in a case that terminal apparatus #2 is “not served by E-UTRA” and/or “not served by NR”. The 12th identification information may be information indicating that terminal apparatus #2 is authorized or not authorized to use the A2X communication via PC5 in a case that terminal apparatus #2 is “not served by E-UTRA” and/or “not served by NR”. The 12th identification information may be included in the 20th identification information.

Next, 13th identification information may be information indicating whether the terminal apparatus includes a UICC. The 13th identification information may be information indicating that the terminal apparatus includes or does not include a UICC. The 13th identification information may be included in the 20th identification information.

The 13th identification information may be information indicating whether terminal apparatus #2 includes a UICC. The 13th identification information may be information indicating that terminal apparatus #2 includes or does not include a UICC. The 13th identification information may be included in the 20th identification information.

Next, the 20th identification information may be an A2X configuration parameter. The 20th identification information may be information for controlling the A2X communication. The 20th identification information may be a configuration parameter for the A2X communication via PC5 and/or a configuration parameter for the A2X communication via Uu.

The 20th identification information may be configured for the terminal apparatus in advance. The 20th identification information may be configured in a USIM. The 20th identification information may be provided as an A2X policy. The 20th identification information may be provided from the A2X application server.

The 20th identification information may include the first identification information, and/or the second identification information, and/or the 12th identification information, and/or the 13th identification information.

### 3. Description of Procedures Used in Each Embodiment

Next, procedures used in each embodiment will be described.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

### 3.1. Registration Procedure

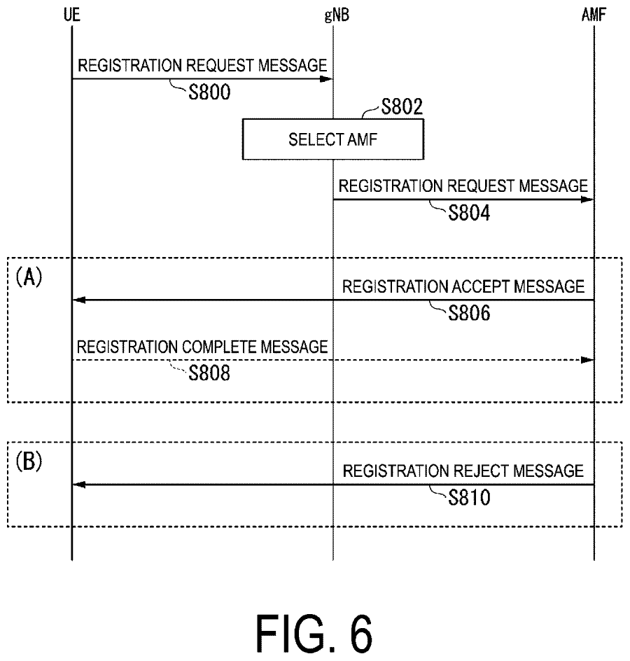

First, the Registration procedure will be described with reference to FIG. 6. The registration procedure is a procedure in the 5GS. In the present section, the present procedure refers to the registration procedure. The registration procedure is a procedure for registration with the access network_B, and/or the core network_B, and/or the DN initiated by the UE. In a case that the UE is in a state of not being registered with the network, for example, the UE can perform the present procedure at any timing, for example, a power input time. In other words, the UE can initiate the present procedure at any timing as long as the UE is in a deregistered state (an RM-DEREGISTERED state). Each of the apparatuses (especially, the UE and the AMF) can transition to a registered state (an RM-REGISTERED state) based on completion of the Registration procedure. Note that the registered state may be managed by each apparatus for each access. Specifically, each apparatus may independently manage the registration state (registered state or deregistered state) for 3GPP access and the registration state for non-3GPP access.

Note that the registration procedure may be a Registration procedure for initial registration. The registration procedure may be a Registration procedure for mobility and periodic registration update. The registration procedure may be referred to as registration.

Furthermore, the registration procedure may be a procedure for updating position registration information of the UE on the network, and/or periodically provide notification of the state of the UE from the UE to the network, and/or updating a specific parameter related to the UE on the network.

The UE may perform the registration procedure after performing SNPN selection or PLMN selection.

The UE may also initiate a registration procedure in a case that the UE has performed mobility across a TA. In other words, the UE may initiate a registration procedure in a case that the UE has moved to a TA different from TAs indicated in a stored TA list. Furthermore, the UE may initiate the registration procedure in a case that a context of each apparatus needs to be updated due to disconnection and/or invalidation of a PDU session. Furthermore, in a case that there has been a change in capability information and/or a preference, related to PDU session establishment of the UE, the UE may initiate the registration procedure. Furthermore, the UE may periodically initiate the registration procedure. Furthermore, the UE may also initiate a registration procedure based on completion of a UE configuration update procedure. Note that the UE is not limited to this configuration, and can perform the registration procedure at any timing.

Furthermore, the UE may also initiate a registration procedure periodically even in a registered state.

Note that the registration procedure performed based on the mobility of the UE and the registration procedure performed periodically may also be expressed as a registration procedure for mobility and registration update. In other words, the registration procedure for mobility and registration update may be a registration procedure performed based on the mobility of the UE or may be a registration procedure performed periodically. Furthermore, the registration procedure for mobility and registration update may also be a registration procedure performed based on configuration update of the UE. Furthermore, the registration procedure for mobility and registration update may also be a registration procedure performed to establish a communication path for transmitting and/or receiving user data. Furthermore, the registration procedure for mobility and registration update may also be a registration procedure performed based on a request from the network. Furthermore, in other words, the registration procedure for mobility and registration update may be a registration procedure other than a registration procedure for initial registration.

Next, each step of the registration procedure will be described. Note that the registration procedure described below may be a registration procedure for initial registration or a registration procedure for mobility and registration update.

First, the UE transmits a Registration request message to the AMF (S800) (S802) (S804) to initiate the registration procedure. Specifically, the UE transmits an RRC message including a registration request message to the 5G AN (or the gNB) (S800). Note that the registration request message is a NAS message. The RRC message may be a control message transmitted and/or received between the UE and the 5G AN (or the gNB). The NAS message is processed in the NAS layer, and the RRC message is processed in the RRC layer. Note that the NAS layer is a layer higher than the RRC layer.

Note that the UE may transmit the registration request message, to thereby indicate that the UE supports each function or indicate the request of the UE to the network.

In case of receiving the RRC message including the registration request message, the 5G AN (or the gNB) selects an AMF to which the registration request message is transferred (S802). Note that the 5G AN (or the gNB) can select an AMF based on information included in the registration request message and/or the RRC message. The 5G AN (or the gNB) extracts the registration request message from the received RRC message and transfers the registration request message to the selected AMF (S804).

The AMF may perform a first condition fulfillment determination in a case that the AMF has received a registration request message. The first condition fulfillment determination is used by the network (or AMF) to determine whether to accept the request of the UE. In a case that the first condition fulfillment determination is true, the AMF initiates the procedure of (A) of FIG. 6, whereas in a case that the first condition fulfillment determination is false, the AMF initiates the procedure of (B) of FIG. 6.

Note that the first condition fulfillment determination may be performed based on reception of the registration request message, and/or the subscriber information, and/or the capability information of the network, and/or the operator policy, and/or the network state, and/or the user registration information, and/or the context stored in the AMF, and/or the like.

For example, the first condition fulfillment determination may be true in a case that the network allows the request from the UE, and the first condition fulfillment determination may be false in a case that the network does not allow the request from the UE. In a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Furthermore, in a case that the transmitted and/or received identification information is allowed, the first condition fulfillment determination may be true, whereas in a case that the transmitted and/or received identification information is not allowed, the first condition fulfillment determination may be false. Note that the conditions for determining whether the first condition fulfillment determination is true or false may not be limited to the conditions described above.

First, the case that the first condition fulfillment determination is true will be described. In the procedure of (A) of FIG. 6, the AMF transmits a Registration accept message to the UE via the 5G AN (or the gNB) as a response message for the registration request message (S806). Note that the registration accept message is a NAS message transmitted and/or received over the N1 interface, but is included in an RRC message and transmitted and/or received between the UE and the 5G AN (the gNB).

The AMF may transmit the registration accept message including the 20th identification information. Note that, by transmitting this identification information, the AMF may indicate that the network supports each function or may indicate that the request of the UE has been accepted.

Furthermore, the AMF may transmit the registration accept message including the 20th identification information, and thereby indicate the content indicated by this identification information to the UE.

Note that the AMF may select or determine whether to include the 20th identification information in the registration accept message based on each piece of received identification information, subscriber information, network capability information, an operator policy, a network state, user registration information, a context stored by the AMF, and/or the like.

The AMF may indicate that the request of the UE has been accepted by transmitting a registration accept message based on each piece of received identification information, subscriber information, network capability information, an operator policy, a network state, user registration information, a context stored by the AMF, and/or the like.

Furthermore, the AMF may also transmit a registration accept message including information indicating that a part of the request of the UE has been rejected or may transmit information indicating that a part of the request of the UE has been rejected to indicate a reason why a part of the request of the UE has been rejected. Furthermore, the UE may also recognize a reason why a part of the request of the UE has been rejected by receiving information indicating that a part of the request of the UE has been rejected. Note that the reason for rejection may be information indicating that content indicated by the identification information received by the AMF is not allowed.

Next, the UE receives the registration accept message from the AMF via the 5G AN (the gNB) (S806). The UE may receive the registration accept message including the 20th identification information from the AMF.

Here, by receiving the registration accept message, the UE may recognize that the request of the UE in the registration request message has been accepted and the content of various pieces of identification information included in the registration accept message.

Next, the UE may or may not transmit a registration complete message to the AMF via the 5G AN (the gNB) as a response message for the registration accept message (S808). Here, although the registration complete message is a NAS message transmitted and/or received over the NI interface, the registration complete message is transmitted and/or received between the UE and the 5G AN (gNB) by being included in an RRC message.

Next, the AMF may or may not receive the registration complete message via the 5G AN (the gNB) (S808).

Each apparatus completes the procedure of (A) of FIG. 6, based on transmission and/or reception of the registration accept message and/or the registration complete message.

The UE may perform SNPN selection or PLMN selection, based on reception of the registration accept message. The UE may perform SNPN selection or PLMN selection, based on transmission of the registration complete message.

Next, the case that the first condition fulfillment determination is false will be described. In the procedure (B) of FIG. 6, the AMF transmits a Registration reject message to the UE via the 5G AN (the gNB) as a response message for the registration request message (S810). Here, the registration reject message is a NAS message transmitted and/or received over the N1 interface, but is included in an RRC message and transmitted and/or received between the UE and the 5G AN (the gNB).

The AMF may transmit the registration reject message including the 20th identification information. Furthermore, the AMF may transmit this identification information, and may thereby indicate that the request of the UE has been rejected or indicate a reason why the request of the UE has been rejected.

Furthermore, the AMF may transmit the registration reject message including the 20th identification information, and thereby indicate the content indicated by the identification information included in the registration reject message to the UE.

Note that the AMF may select or determine whether to include the 20th identification information in the registration reject message based on each piece of received identification information, subscriber information, network capability information, an operator policy, a network state, user registration information, a context stored by the AMF, and/or the like.

Furthermore, the AMF may also transmit a registration reject message to indicate that the request of the UE in the registration request message has been rejected. Furthermore, the AMF may also transmit a registration reject message including information indicating a reason for rejection or may transmit a reason for rejection to indicate the reason for rejection. Furthermore, the UE may also recognize a reason why the request of the UE has been rejected by receiving information indicating the reason why the request of the UE has been rejected. Note that the reason for rejection may be information indicating that content indicated by the identification information received by the AMF is not allowed.

Next, the UE receives the registration reject message from the AMF via the 5G AN (the gNB) (S810). The UE may receive the registration reject message including the 20th identification information from the AMF. By receiving the registration reject message, the UE may recognize that the request of the UE in the registration request message has been rejected and the content of various pieces of identification information included in the registration reject message.

### Here, the UE may perform SNPN selection or PLMN selection in a case of Receiving the registration reject message.

The UE may also recognize that the request of the UE has been rejected in a case that the UE does not receive a registration reject message even in a case that a prescribed period of time has elapsed after transmitting a registration request message.

Each apparatus completes the procedure (B) in the present procedure based on transmission and/or reception of the registration reject message.

Note that the procedure of (B) of FIG. 6 may be initiated in a case that the procedure of (A) of FIG. 6 is cancelled.

Each apparatus completes the registration procedure, based on completion of the procedure of (A) or (B) of FIG. 6. Note that, based on completion of the procedure of (A) of FIG. 6, each apparatus may transition to a state (RM_REGISTERED state) in which the UE is registered with the network. Based on completion of the procedure of (B) of FIG. 6, each apparatus may maintain a state (RM_DEREGISTERED state) in which the UE is not registered with the network, or may transition to a state in which the UE is not registered with the network.

Furthermore, each apparatus may perform processing based on information transmitted and/or received in the registration procedure, based on completion of the registration procedure. For example, in a case that information indicating that a part of the request from the UE has been rejected is transmitted and/or received, the cause for rejection of the request from the UE may be recognized. Furthermore, each apparatus may also perform the present procedure again or may perform a registration procedure with the core network_B or another cell based on the reason why the request of the UE has been rejected.

Moreover, the UE may store the identification information received along with the registration accept message or the registration reject message or may recognize determination of the network based on the completion of the registration procedure.

Furthermore, the UE may perform SNPN selection or PLMN selection, based on completion of the registration procedure.

### 3.2. PDU Session Establishment Procedure

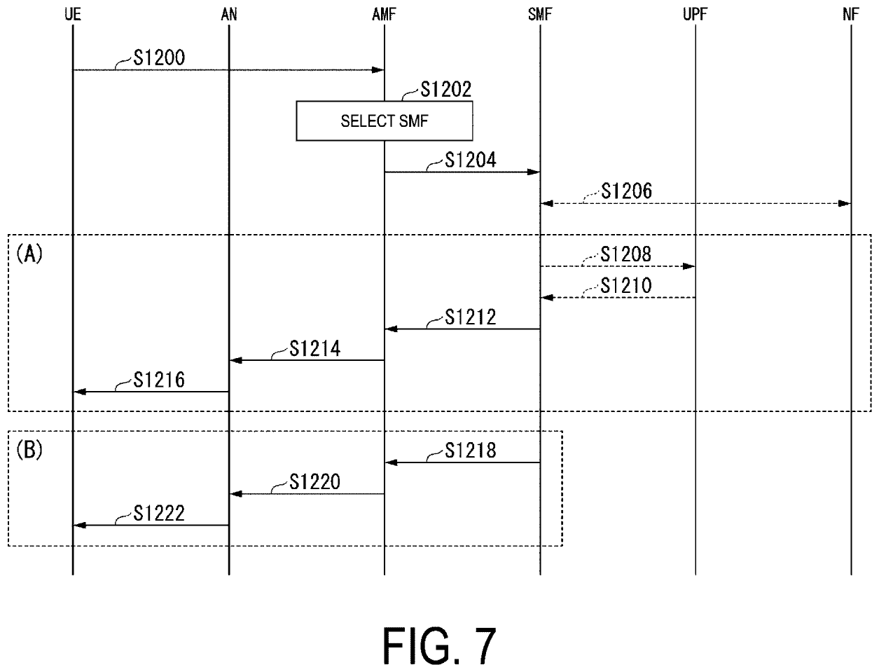

Next, a PDU session establishment procedure will be described with reference to FIG. 7. The PDU session establishment procedure may be hereinafter referred to as the present procedure. The PDU session establishment procedure may be an SM procedure.

Note that, before the present procedure, the registration procedure may be performed one or more times.

Next, each step of the PDU session establishment procedure will be described.

First, the UE transmits a PDU session establishment request message to the SMF (S1200) (S1202) (S1204), and initiates the PDU session establishment procedure. Then, the SMF receives the PDU session establishment request message from the UE.

Specifically, the UE transmits a NAS message including an N1 SM container including the PDU session establishment request message to the AMF via the access network (S1200), to thereby initiate the PDU session establishment procedure. The NAS message may be, for example, a message transmitted via the N1 interface, and may be an uplink NAS transport (UL NAS TRANSPORT) message.

Note that the UE may transmit the PDU session establishment request message or the NAS message, to thereby indicate that the UE supports each function or indicate the request of the UE.

Next, in a case that the AMF receives the NAS message, the AMF can recognize the request of the UE, and/or the content of the information and the like (a message, a container, information) included in the NAS message.

Next, the AMF selects the SMF as a transfer destination of at least a part of the information and the like (a message, a container, information) included in the NAS message received from the UE (S1202). Note that the AMF may select the SMF as a transfer destination, based on the information and the like (a message, a container, information) included in the NAS message, and/or the subscriber information and/or the network capability information and/or the UE policy and/or the operator policy and/or the network state and/or the user registration information and/or the context stored in the AMF, or the like.

Next, the AMF transmits at least a part of the information and the like (a message, a container, information) included in the NAS message received from the UE to the selected SMF via the N11 interface, for example (S1204).

Next, in a case that the SMF receives the information and the like (a message, a container, information) transmitted from the AMF, the SMF can recognize the request of the UE, and/or the content of the information and the like (a message, a container, information) received from the AMF.

Here, the SMF may perform second condition fulfillment determination. The second condition fulfillment determination may be performed for determining whether or not the network accepts the request from the UE. In a case of determining the second condition fulfillment determination to be true, the SMF may initiate the procedure of (A) of FIG. 7, whereas in a case of determining the second condition fulfillment determination to be false, the SMF may initiate the procedure of (B) of FIG. 7.

Note that the second condition fulfillment determination may be performed by an NF other than the SMF. In a case that the NF other than the SMF performs the second condition fulfillment determination, the SMF may provide the NF with at least a part of information necessary for performing the second condition fulfillment determination, specifically, information received from the UE (S1206). Then, in a case that the NF determines true or false of the second condition fulfillment determination based on the information received from the SMF, the NF may notify the SMF of information including results (in other words, true or false) of the second condition fulfillment determination. The SMF may determine the identification information and/or the control message to be transmitted to the UE, based on the results of the second condition fulfillment determination received from the NF.

Note that the second condition fulfillment determination may be performed based on the information and the like (a message, a container, information) received from the AMF, and/or the subscriber information (subscription information) and/or the network capability information and/or the UE policy and/or the operator policy and/or the network state and/or the user registration information and/or the context stored in the SMF, or the like.

For example, in a case that the network allows the request from the UE, the second condition fulfillment determination may be determined to be true, whereas in a case that the network does not allow the request from the UE, the second condition fulfillment determination may be determined as false. In a case that a network as a connection destination of the UE and/or an apparatus in the network supports the function requested by the UE, the second condition fulfillment determination may be determined to be true, whereas in a case that the network and/or the apparatus does not support the function requested by the UE, the second condition fulfillment determination may be determined as false. In a case that the transmitted and/or received identification information is allowed, the second condition fulfillment determination may be determined to be true, whereas in a case that the transmitted and/or received identification information is not allowed, the second condition fulfillment determination may be determined as false.

Note that the condition for determining true or false of the second condition fulfillment determination need not necessarily be limited to the condition described above.

Next, each step of the procedure of (a) of FIG. 7 will be described.

The SMF may select the UPF for a PDU session to be established, and transmit an N4 session establishment request message to the selected UPF via the N4 interface, for example (S1208). In the N4 session establishment request message, at least a part of a PCC rule received from the PCF may be included.

Here, the SMF may select one or more UPFs, based on the information and the like (a message, a container, information) received from the AMF, and/or the information such as the PCC rule received from the PCF, and/or the subscriber information, and/or the network capability information, and/or the UE policy, and/or the operator policy, and/or the network state, and/or the user registration information, and/or the context stored in the SMF, or the like. In a case that multiple UPFs are selected, the SMF may transmit the N4 session establishment request message to each UPF. Here, it is assumed that the UPF is selected.

Next, in a case that the UPF receives the N4 session establishment request message (S1208), the UPF can recognize the content of the information received from the SMF. The UPF may transmit an N4 session establishment response message to the SMF via the N4 interface, for example, based on reception of the N4 session establishment request message (S1210).

Next, in a case that the SMF receives the N4 session establishment response message as a response message for the N4 session establishment request message, the SMF can recognize the content of the information received from the UPF.

Next, the SMF transmits a PDU session establishment accept message to the UE, based on reception of the PDU session establishment request message, and/or selection of the UPF, and/or reception of the N4 session establishment response message, and/or the like (S1212) (S1214) (S1216).

Specifically, the SMF transmits the N1 SM container, and/or N2 SM information, and/or the PDU session ID to the AMF via the N11 interface, for example, based on reception of the PDU session establishment request message, and/or selection of the UPF, and/or reception of the N4 session establishment response message, and/or the like (S1212). Here, the N1 SM container may include the PDU session establishment accept message. Furthermore, the PDU session ID may be included in the PDU session establishment accept message.

Next, the AMF that has received the N1 SM container, and/or the N2 SM information, and/or the PDU session ID transmits the NAS message to the UE via the access network (S1214) (S1216). Here, the NAS message is transmitted via the N1 interface, for example. The NAS message may be a downlink NAS transport (DL NAS TRANSPORT) message.

Specifically, in a case that the AMF transmits an N2 PDU session request message to the access network (S1214), the access network that has received the N2 PDU session request message transmits the NAS message to the UE (S1216). Here, the N2 PDU session request message may include the NAS message and/or the N2 SM information. The NAS message may include the PDU session ID and/or the N1 SM container.

The PDU session establishment accept message may be a response message for the PDU session establishment request. The PDU session establishment accept message may indicate that establishment of the PDU session has been accepted.

Here, the SMF and/or the AMF may transmit the PDU session establishment accept message, and/or the N1 SM container, and/or the PDU session ID, and/or the NAS message, and/or the N2 SM information, and/or the N2 PDU session request message, to thereby indicate that at least a part of the request from the UE by the PDU session establishment request message has been accepted.

Here, the SMF and/or the AMF may include the 20th identification information in the PDU session establishment accept message, and/or the N1 SM container, and/or the NAS message, and/or the N2 SM information, and/or the N2 PDU session request message for transmission.

Note that, the SMF may transmit this identification information and/or the PDU session establishment accept message, to thereby indicate that the network supports each function, indicate that the request of the UE has been accepted, indicate that the request from the UE is not allowed, or indicate information of a combination of these.

Note that the SMF and/or the AMF may determine which piece of identification information is to be included in the PDU session establishment accept message, and/or the N1 SM container, and/or the NAS message, and/or the N2 SM information, and/or the N2 PDU session request message, based on each piece of received identification information, and/or the subscriber information, and/or the network capability information, and/or the UE policy, and/or the operator policy, and/or the network state, and/or the user registration information, and/or the context stored in the SMF and/or the AMF, or the like.

Next, the UE receives the PDU session establishment accept message and/or the NAS message from the SMF (S1212) (S1214) (S1216). The UE may receive the PDU session establishment accept message and/or the NAS message including the 20th identification information from the SMF. In a case of receiving the PDU session establishment accept message and/or the NAS message, the UE may recognize that the request from the UE by the PDU session establishment request message has been accepted, and/or the content of the information and the like (a message, a container, information) included in the NAS message.

In a case of receiving the PDU session establishment accept message and/or the NAS message, the UE may perform the behavior in a case of receiving each piece of identification information included in the PDU session establishment accept message and/or the NAS message.

Next, each step of the procedure of (b) of FIG. 7 will be described.

First, the SMF transmits a PDU session establishment reject message to the UE (S1218) (S1220) (S1222).

Specifically, based on reception of the PDU session establishment request message, the SMF transmits the N1 SM container and/or the PDU session ID to the AMF via the N11 interface, for example (S1218). Here, the N1 SM container may include a PDU session establishment reject message. Furthermore, the PDU session ID may be included in the PDU session establishment reject message.

Next, the AMF that has received the N1 SM container and/or the PDU session ID transmits the NAS message to the UE via the access network (S1220) (S1222). Here, the NAS message is transmitted via the N1 interface, for example. The NAS message may be a downlink NAS transport (DL NAS TRANSPORT) message. The NAS message may include the PDU session ID and/or the N1 SM container.

The PDU session establishment reject message may be a response message for the PDU session establishment request. The PDU session establishment reject message may indicate that establishment of the PDU session has been rejected.

Here, the SMF and/or the AMF may transmit the PDU session establishment reject message, and/or the N1 SM container, and/or the PDU session ID, and/or the NAS message, to thereby indicate that the request from the UE on the PDU session establishment request message has been rejected.

Note that the SMF may transmit the PDU session establishment reject message, to thereby indicate that the request from the UE has been rejected, indicate that the request from the UE is not allowed, or indicate information of a combination of these.

Here, the SMF and/or the AMF may include the 20th identification information in the PDU session establishment reject message, and/or the N1 SM container, and/or the NAS message, and/or the N2 SM information, and/or the N2 PDU session request message for transmission.

Note that the SMF and/or the AMF may determine which piece of identification information is to be included in the PDU session establishment reject message, and/or the N1SM container, and/or the NAS message, and/or the N2 SM information, and/or the N2 PDU session request message, based on each piece of received identification information, and/or the subscriber information, and/or the network capability information, and/or the UE policy, and/or the operator policy, and/or the network state, and/or the user registration information, and/or the context stored in the SMF and/or the AMF, or the like.

Furthermore, the SMF and/or the AMF may include information indicating that the request of the UE has been rejected in the PDU session establishment reject message, and/or the N1 SM container, and/or the NAS message, and/or the N2 SM information, and/or the N2 PDU session request message for transmission, or may transmit the information indicating that the UE request has been rejected to thereby indicate a reason why the request of the UE has been rejected. Furthermore, the UE may recognize the reason why the request of the UE has been rejected by receiving the information indicating that the request of the UE has been rejected.

Note that the reason for rejection may be information indicating that the content indicated by the identification information received by the SMF and/or the AMF is not allowed and/or is unavailable.

Next, the UE receives the NAS message and/or the PDU session establishment reject message (S1218) (S1220) (S1222). The UE may receive the PDU session establishment reject message and/or the NAS message including the 20th identification information from the SMF. In a case of receiving the PDU session establishment reject message and/or the NAS message, the UE may recognize that the request from the UE by the PDU session establishment request message has been rejected, and/or the content of the information and the like (a message, a container, information) included in the NAS message.

In a case of receiving the PDU session establishment reject message and/or the NAS message, the UE may perform the behavior in a case of receiving each piece of identification information included in the PDU session establishment reject message and/or the NAS message.

Each apparatus may complete the present procedure, based on transmission and/or reception of the PDU session establishment accept message. Each apparatus may establish a PDU session based on completion of the present procedure. In this case, each apparatus may transition to a state capable of communicating with the DN using the established PDU session.

Each apparatus may complete the present procedure, based on transmission and/or reception of the PDU session establishment reject message. In this case, each apparatus cannot establish a PDU session, and thus cannot communicate with the DN in a case that there is no PDU session that has been already established.

Note that each processing step illustrated above that the UE performs based on reception of each piece of identification information may be performed during the present procedure or after the present procedure is completed or may be performed based on completion of the present procedure after the present procedure is completed.

### 3.3. Network-Requested UE Policy Management Procedure

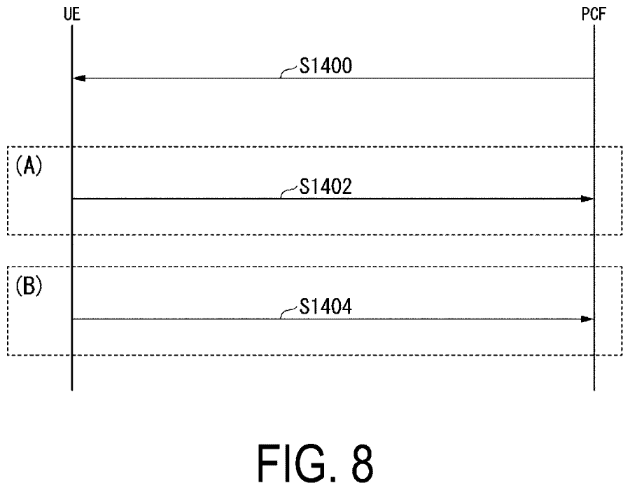

Next, a Network-requested UE policy management procedure will be described with reference to FIG. 8. The network-requested UE policy management procedure may be hereinafter referred to as the present procedure.

The present procedure may be initiated in a case that the PCF desires to update the UE policy.

Note that, before the present procedure, the registration procedure and/or the PDU session establishment procedure may or may not be performed one or more times.

Next, each step of the present procedure will be described.

First, the PCF transmits a manage UE policy command message to the UE via the AMF (S1400). The PCF may transmit the manage UE policy command message including the 20th identification information to the UE.

Here, by transmitting the 20th identification information, the PCF may indicate the content indicated by the 20th identification information to the UE.

Note that the PCF may determine whether or not to transmit the manage UE policy command message and/or the 20th identification information, based on a UE state, and/or information received from the A2X application server, and/or information received from another NF, and/or the like.

Next, the UE receives the manage UE policy command message from the PCF via the AMF. The UE may receive the manage UE policy command message including the 20th identification information from the PCF.

Furthermore, the UE may recognize or store the received identification information, or may recognize determination of the network, based on reception of the manage UE policy command message.

The UE can perform a third condition fulfillment determination in a case of receiving the manage UE policy command message. The third condition fulfillment determination is for determining whether or not the UE accepts the request of the network. In a case that the third condition fulfillment determination is true, the UE initiates the procedure of (A) of FIG. 8, and in a case that the third condition fulfillment determination is false, the UE initiates the procedure of (B) of FIG. 8.

Note that the third condition fulfillment determination may be performed based on reception of the manage UE policy command message, and/or each piece of identification information included in the manage UE policy command message, and/or subscriber information, and/or UE capability information, and/or the UE policy, and/or the UE state, and/or the context stored in the UE, and/or the like. For example, in a case that the UE allows the request of the network, the third condition fulfillment determination may be true, and in a case that the UE does not allow the request of the network, the third condition fulfillment determination may be false. In a case that the UE supports the function requested by the network, the third condition fulfillment determination may be true, and in a case that the UE does not support the function requested by the network, the third condition fulfillment determination may be false. Furthermore, in a case that the transmitted and/or received identification information is allowed, the third condition fulfillment determination may be true, and in a case that the transmitted and/or received identification information is not allowed, the third condition fulfillment determination may be false. Note that the conditions for determining whether the third condition fulfillment determination is true or false may not be limited to the conditions described above.

First, the case that the third condition fulfillment determination is true will be described.

In the procedure of (A) of FIG. 8, the UE transmits a manage UE policy complete message to the PCF via the AMF as a response message for the manage UE policy command message (S1402).

Next, the PCF receives the manage UE policy complete message from the UE via the AMF.

Furthermore, the PCF may recognize determination of the UE, based on reception of the manage UE policy complete message.

Each apparatus may complete the procedure of (A) of FIG. 8, based on transmission and/or reception of the manage UE policy command message and/or the manage UE policy complete message.

Next, the case that the third condition fulfillment determination is false will be described.

In the procedure of (B) of FIG. 8, the UE transmits a manage UE policy command reject message to the PCF via the AMF as a response message for the manage UE policy command message (S1404).

Next, the PCF receives the manage UE policy command reject message from the UE via the AMF.

Furthermore, the PCF may recognize determination of the UE, based on reception of the manage UE policy command reject message.

Each apparatus may complete the procedure of (B) of FIG. 8, based on transmission and/or reception of the manage UE policy command message and/or the manage UE policy command reject message.

Furthermore, each apparatus may complete the present procedure, based on completion of the processing described above, and/or transmission and/or reception of the manage UE policy command message, and/or transmission and/or reception of the manage UE policy complete message, and/or transmission and/or reception of the manage UE policy command reject message.

Furthermore, each apparatus may perform processing based on identification information transmitted and/or received in the present procedure, based on completion of the present procedure.

Based on completion of the network-requested UE policy management procedure, the UE may add a new UE policy, may change the UE policy stored in the UE, or may delete the UE policy stored in the UE.

### 3.4. UE-Requested A2X Policy Provisioning Procedure

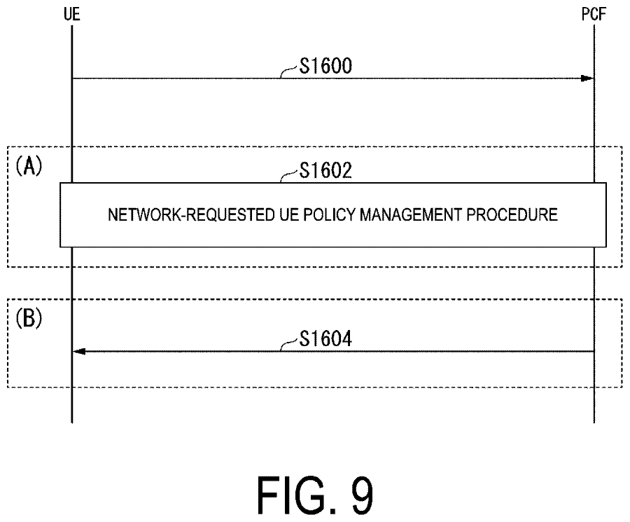

Next, a UE-requested A2X policy provisioning procedure will be described with reference to FIG. 9. The UE-requested A2X policy provisioning procedure may be hereinafter referred to as the present procedure.

The present procedure may be initiated in a case that the UE requests the UE policy or the A2X policy.

Note that, before the present procedure, the registration procedure and/or the PDU session establishment procedure may or may not be performed one or more times.

Next, each step of the present procedure will be described.

First, the UE transmits a UE policy provisioning request message to the PCF via the AMF (S1600).

Next, the PCF receives the UE policy provisioning request message from the UE via the AMF.

Furthermore, the PCF may recognize determination of the UE, based on reception of the UE policy provisioning request message.

The PCF can perform a fourth condition fulfillment determination in a case of receiving the UE policy provisioning request message. The fourth condition fulfillment determination is for determining whether or not the network accepts the request of the UE. In a case that the fourth condition fulfillment determination is true, the PCF initiates the procedure of (A) of FIG. 9, and in a case that the fourth condition fulfillment determination is false, the PCF initiates the procedure of (B) of FIG. 9.

Note that the fourth condition fulfillment determination may be performed based on reception of the UE policy provisioning request message, and/or each piece of identification information included in the UE policy provisioning request message, and/or subscriber information, and/or capability information of the network, and/or the operator policy, and/or a state of the network, and/or registration information of the user, and/or a context stored in the PCF, and/or the like. For example, the fourth condition fulfillment determination may be true in a case that the network allows the request from the UE, and the fourth condition fulfillment determination may be false in a case that the network does not allow the request from the UE. In a case that a network with which the UE is to be registered and/or an apparatus in the network supports the function requested by the UE, the fourth condition fulfillment determination may be true, whereas in a case that the network and/or the apparatus does not support the function requested by the UE, the fourth condition fulfillment determination may be false. Furthermore, in a case that the transmitted and/or received identification information is allowed, the fourth condition fulfillment determination may be true, and in a case that the transmitted and/or received identification information is not allowed, the fourth condition fulfillment determination may be false. Note that the conditions for determining whether the fourth condition fulfillment determination is true or false may not be limited to the conditions described above.

First, the case that the fourth condition fulfillment determination is true will be described.

The PCF may perform a network-requested policy management procedure in the procedure of (A) of FIG. 9 (S1602). Here, as the network-requested policy management procedure, the procedure described in above Section 3.3 may be performed.

Each apparatus may complete the procedure of (A) of FIG. 9, based on transmission and/or reception of the UE policy provisioning request message and/or completion of the network-requested policy management procedure.

Next, the case that the fourth condition fulfillment determination is false will be described.

In the procedure of (B) of FIG. 9, the PCF transmits a UE policy provisioning reject message to the UE via the AMF as a response message for the UE policy provisioning request message (S1604). The PCF may transmit the UE policy provisioning reject message including the 20th identification information to the UE.

Here, by transmitting the 20th identification information, the PCF may indicate the content indicated by each piece of identification information to the UE.

The PCF may determine whether or not to transmit the UE policy provisioning reject message and/or the 20th identification information, based on a UE state, and/or information received from the A2X application server, and/or information received from another NF, and/or the like.

Next, the UE receives the UE policy provisioning reject message from the PCF via the AMF. The UE may receive the UE policy provisioning reject message including the 20th identification information from the PCF.

Furthermore, the UE may recognize determination of the network, based on reception of the UE policy provisioning reject message.

In a case of receiving the UE policy provisioning reject message, the UE may perform the behavior in a case of receiving the 20th identification information included in the UE policy provisioning reject message.

Each apparatus may complete the procedure of (B) of FIG. 9, based on transmission and/or reception of the UE policy provisioning request message and/or the UE policy provisioning reject message.

Furthermore, each apparatus may complete the present procedure, based on completion of the processing described above, and/or transmission and/or reception of the UE policy provisioning request message, and/or completion of the network-requested policy management procedure, and/or transmission and/or reception of the UE policy provisioning reject message.

Furthermore, each apparatus may perform processing based on identification information transmitted and/or received in the present procedure, based on completion of the present procedure.

Note that, based on completion of the present procedure, the UE may add a new UE policy, may change the UE policy stored in the UE, or may delete the UE policy stored in the UE.

### 3.5 PC5 Unicast Link Establishment Procedure

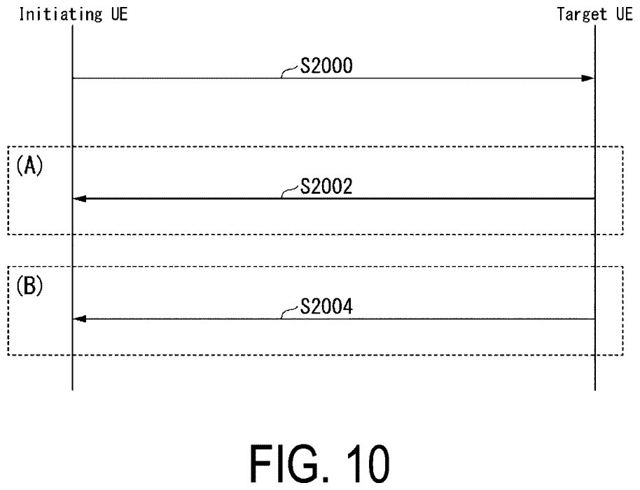

Next, a PC5 unicast link establishment procedure will be described with reference to FIG. 10. The PC5 unicast link establishment procedure may be hereinafter referred to as the present procedure. The present procedure may be an A2X procedure, or may be a procedure for A2X communication. The present procedure may be an A2X procedure for DAA, or may be a procedure for unicast mode A2X communication on NR-PC5. The present procedure may be a procedure for direct C2 communication.

Note that, before the present procedure, the registration procedure, and/or the PDU session establishment procedure, and/or service authorization and provision may or may not be performed one or more times.

In the present procedure, the initiating UE and the target UE may be present.

Note that, in the present procedure, the initiating UE and the target UE may transmit and/or receive each control message over PC5. Each UE may be in a unicast mode. Each UE may include the UE policy for BRID and/or DAA.

Next, each step of the present procedure will be described.

First, the initiating UE transmits a direct link establishment request message to the target UE (S2000). The initiating UE may transmit the direct link establishment request message including one or more pieces of identification information out of the first identification information to the second identification information.

Note that the initiating UE may transmit these pieces of identification information, to thereby indicate that the initiating UE supports each function, or indicate the request from the initiating UE. Furthermore, in a case that multiple pieces of identification information are transmitted and/or received, two or more pieces of identification information of these pieces of identification information may be configured as one or more pieces of identification information. Note that information indicating support for each function and information indicating a request to use each function may be transmitted and/or received with the same piece of identification information or may be transmitted and/or received as different pieces of identification information.

Here, by transmitting the direct link establishment request message, the initiating UE may indicate the content of each piece of identification information to the target UE. By transmitting one or more pieces of identification information out of the first identification information to the second identification information, the initiating UE may indicate the content of each piece of identification information to the target UE.

Note that the initiating UE may select or determine whether to include, in the direct link establishment request message, one or more pieces of identification information out of the first identification information to the second identification information, based on subscriber information and/or a network state and/or user registration information and/or a context stored in the UE, or the like.

By transmitting the direct link establishment request message, the initiating UE may request establishment of a direct link.

Next, the target UE receives the direct link establishment request message from the initiating UE. The target UE may receive the direct link establishment request message including one or more pieces of identification information out of the first identification information to the second identification information from the initiating UE.

In a case of receiving the direct link establishment request message, the target UE may recognize the content requested by the initiating UE and/or the content of information and the like (a message, a container, identification information) included in the direct link establishment request message.

Here, the target UE may perform a fifth condition fulfillment determination. The fifth condition fulfillment determination may be used by the target UE to determine whether to accept the request from the initiating UE. In a case of determining the fifth condition fulfillment determination to be true, the target UE may initiate the procedure of (A) of FIG. 10, whereas in a case of determining the fifth condition fulfillment determination to be false, the target UE may initiate the procedure of (B) of FIG. 10.

Note that the fifth condition fulfillment determination may be performed based on the information and the like (a message, a container, information) received from the initiating UE, and/or the subscriber information (subscription information), and/or the network capability information, and/or the UE policy, and/or the operator policy, and/or the network state, and/or the user registration information, and/or the context stored by the target UE, and/or the like.

For example, in a case that the target UE allows the request from the initiating UE, the fifth condition fulfillment determination may be determined to be true, whereas in a case that the target UE does not allow the request from the initiating UE, the fifth condition fulfillment determination may be determined to be false. In a case that the target UE supports the function requested by the initiating UE, the fifth condition fulfillment determination may be determined to be true, whereas in a case that the target UE does not support the function requested by the initiating UE, the fifth condition fulfillment determination may be determined to be false. In a case that the transmitted and/or received identification information is allowed, the fifth condition fulfillment determination may be determined to be true, whereas in a case that the transmitted and/or received identification information is not allowed, the fifth condition fulfillment determination may be determined to be false.

Note that the conditions for determining whether the fifth condition fulfillment determination is true or false may not be limited to the conditions described above.

Next, each step of the procedure of (a) of FIG. 10 will be described.

The target UE transmits a direct link establishment accept message to the initiating UE, based on reception of the direct link establishment request message (S2002). The target UE may transmit the direct link establishment accept message including one or more pieces of identification information out of the 10th identification information to the 13th identification information to the initiating UE.

Here, by transmitting the direct link establishment accept message, the target UE may indicate that at least a part of the request from the initiating UE has been accepted. By transmitting one or more pieces of identification information out of the 10th identification information to the 13th identification information, the target UE may indicate that at least a part of the request from the initiating UE has been accepted.

Note that, by transmitting these pieces of identification information and/or the direct link establishment accept message, the target UE may indicate that the target UE supports the functions, may indicate that the request from the initiating UE has been accepted, may indicate that the request from the initiating UE has not been allowed, or may indicate information obtained by combining the above-described pieces of information. Furthermore, in a case that multiple pieces of identification information are transmitted and/or received, two or more pieces of identification information of these pieces of identification information may be configured as one or more pieces of identification information. Note that information indicating support of each function and information indicating a request for use of each function may be transmitted and/or received as the same piece of identification information, or may be transmitted and/or received as different pieces of identification information.

Note that the target UE may determine which identification information is to be included in the direct link establishment accept message based on each piece of received identification information, and/or the subscriber information, and/or the network capability information, and/or the UE policy, and/or the operator policy, and/or the network state, and/or the user registration information, and/or the context stored by the target UE, and/or the like.

The direct link establishment accept message may be a response message for the direct link establishment request message. The direct link establishment accept message may indicate that the direct link establishment request message has been accepted.

Next, the initiating UE receives the direct link establishment accept message from the target UE.

In a case of receiving the direct link establishment accept message, the initiating UE can recognize that the request from the initiating UE has been accepted and/or the content of information and the like (a message, a container, identification information) included in the direct link establishment accept message.

Each apparatus may complete the procedure of (A) of FIG. 10, based on transmission and/or reception of the direct link establishment request message and/or the direct link establishment accept message. Each apparatus may establish a PC5 unicast link, based on completion of the present procedure. In this case, each apparatus may transition to a state in which communication using the PC5 unicast link can be performed.

Next, each step of the procedure of (b) of FIG. 10 will be described.

First, the target UE transmits a direct link establishment reject message to the initiating UE, based on reception of the direct link establishment request message (S2004). The target UE may transmit the direct link establishment reject message including one or more pieces of identification information out of the 10th identification information to the 13th identification information to the initiating UE.

The direct link establishment reject message may be a response message for the direct link establishment request message. The direct link establishment reject message may indicate that the direct link establishment request message has been rejected.

Note that, by transmitting the direct link establishment reject message, the target UE may indicate that the request from the initiating UE has been rejected.

Note that the target UE may determine which identification information is to be included in the direct link establishment reject message based on each piece of received identification information, and/or the subscriber information, and/or the network capability information, and/or the UE policy, and/or the operator policy, and/or the network state, and/or the user registration information, and/or the context stored by the target UE, and/or the like.

Next, the initiating UE receives the direct link establishment reject message from the target UE. The initiating UE may receive the direct link establishment reject message including one or more pieces of identification information out of the 10th identification information to the 13th identification information from the target UE.

In a case of receiving the direct link establishment reject message, the initiating UE may recognize that the request from the initiating UE has been rejected and/or the content of information and the like (a message, a container, identification information) included in the direct link establishment reject message.

Each apparatus may complete the procedure of (B) of FIG. 10, based on transmission and/or reception of the direct link establishment request message and/or the direct link establishment reject message. In this case, each apparatus may be unable to establish a PC5 unicast link. Each apparatus may be in a state in which communication using the PC5 unicast link cannot be performed.

Each apparatus may complete the present procedure, based on transmission and/or reception of the direct link establishment request message, and/or the direct link establishment accept message, and/or the direct link establishment reject message.

Note that the behavior of each UE based on the reception of each piece of identification information may be performed after completion of the present procedure.

### 4. Embodiments

Next, each embodiment will be described.

### 4.1. First Embodiment

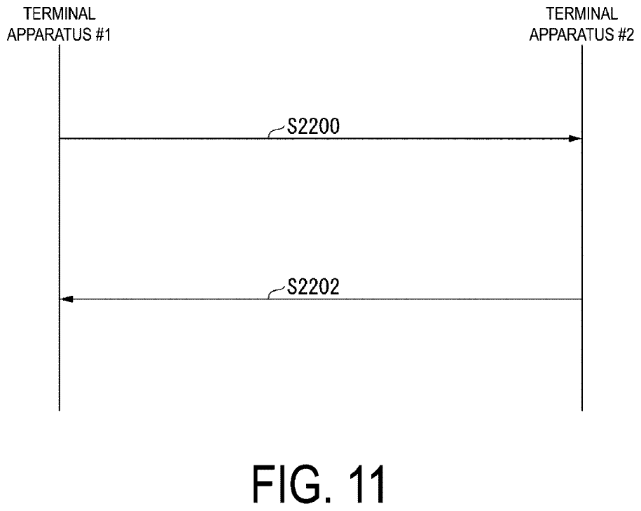

First, a first embodiment will be described with reference to FIG. 11. In the present section, the first embodiment may be referred to as the present embodiment.

In the present embodiment, the registration procedure, and/or the PDU session establishment procedure, and/or the network-requested UE policy management procedure, and/or the UE-requested A2X policy provisioning procedure, and/or the PC5 unicast link establishment procedure may be performed. Before the present embodiment, these procedures may be performed.

In the present embodiment, a first control message may be the direct link establishment request message. A second control message may be the direct link establishment accept message or the direct link establishment reject message. The first and/or second control message may be a message used in the A2X procedure, or may be a message used in DAA.

In the present embodiment, terminal apparatus #1 and terminal apparatus #2 may be present. Note that each terminal apparatus may be the UAV. Terminal apparatus #1 may be the initiating UE. Terminal apparatus #2 may be the target UE. Each terminal apparatus may be in a unicast mode. Each terminal apparatus may include the UE policy for BRID and/or DAA.

Terminal apparatus #1 and/or terminal apparatus #2 may store the 20th identification information.

Each step of the present embodiment will be described below.

First, terminal apparatus #1 may transmit a first control message to terminal apparatus #2 (S2200). Terminal apparatus #1 may transmit the first control message including one or more pieces of identification information out of the first identification information to the second identification information to terminal apparatus #2.

Here, by transmitting one or more pieces of identification information out of the first identification information to the second identification information, terminal apparatus #1 may indicate the content indicated by each piece of identification information to terminal apparatus #2.

Specifically, by transmitting the first identification information, terminal apparatus #1 may indicate whether terminal apparatus #1 is authorized to use the A2X communication via PC5 in a case that terminal apparatus #1 is “not served by E-UTRA” and/or “not served by NR” to terminal apparatus #2. By transmitting the first identification information, terminal apparatus #1 may indicate that terminal apparatus #1 is authorized or not authorized to use the A2X communication via PC5 in a case that terminal apparatus #1 is “not served by E-UTRA” and/or “not served by NR”to terminal apparatus #2.

By transmitting the second identification information, terminal apparatus #1 may indicate whether terminal apparatus #1 includes a UICC to terminal apparatus #2. By transmitting the second identification information, terminal apparatus #1 may indicate that terminal apparatus #1 includes or does not include a UICC to terminal apparatus #2.

In a case that (a) terminal apparatus #1 does not include a UICC, and/or (b) terminal apparatus #1 is not authorized to use the A2X communication via PC5 in a case that terminal apparatus #1 is “not served by E-UTRA” and/or “not served by NR”, terminal apparatus #1 need not transmit the first identification information and/or the second identification information, need not include the first identification information and/or the second identification information in the first control message, or need not transmit the first control message.

In a case that (a) terminal apparatus #1 does not include a UICC, and/or (b) terminal apparatus #1 does not include the first identification information and/or the 20th identification information, terminal apparatus #1 need not transmit the first identification information and/or the second identification information, need not include the first identification information and/or the second identification information in the first control message, or need not transmit the first control message.

In a case that (a) terminal apparatus #1 does not include a UICC, and/or (b) terminal apparatus #1 includes the first identification information and/or the 20th identification information, terminal apparatus #1 need not transmit the first identification information and/or the second identification information, need not include the first identification information and/or the second identification information in the first control message, or need not transmit the first control message.

Terminal apparatus #1 may recognize (a) whether terminal apparatus #2 includes a UICC, and/or (b) whether terminal apparatus #2 is authorized to use the A2X communication via PC5 in a case that terminal apparatus #2 is “not served by E-UTRA” and/or “not served by NR”, based on the 20th identification information.

In a case that (a) terminal apparatus #2 does not include a UICC, and/or (b) terminal apparatus #2 is not authorized to use the A2X communication via PC5 in a case that terminal apparatus #2 is “not served by E-UTRA” and/or “not served by NR”, terminal apparatus #1 need not transmit the first identification information and/or the second identification information, need not include the first identification information and/or the second identification information in the first control message, or need not transmit the first control message.

Note that terminal apparatus #1 may determine whether or not to transmit the first control message and/or each piece of identification information, based on a state of terminal apparatus #1, and/or information received from the network, and/or the like.

Next, terminal apparatus #2 may receive the first control message from terminal apparatus #1 (S2200). Terminal apparatus #2 may receive the first control message including one or more pieces of identification information out of the first identification information to the second identification information from terminal apparatus #1.

Furthermore, terminal apparatus #2 may recognize or store the received identification information, or may recognize determination of terminal apparatus #1, based on reception of the first control message. In a case of receiving the first control message, terminal apparatus #2 may perform the behavior in a case of receiving each piece of identification information.

Specifically, in a case of receiving the first identification information, terminal apparatus #2 may recognize whether terminal apparatus #1 is authorized to use the A2X communication via PC5 in a case that terminal apparatus #1 is “not served by E-UTRA” and/or “not served by NR”. In a case of receiving the first identification information, terminal apparatus #2 may recognize that terminal apparatus #1 is authorized or not authorized to use the A2X communication via PC5 in a case that terminal apparatus #1 is “not served by E-UTRA” and/or “not served by NR”.

In a case of receiving the second identification information, terminal apparatus #2 may recognize whether terminal apparatus #1 includes a UICC. In a case of receiving the second identification information, terminal apparatus #2 may recognize that terminal apparatus #1 includes or does not include a UICC.

In a case of receiving the first identification information and/or the second identification information, terminal apparatus #2 may store a state of terminal apparatus #1 and/or information associated with terminal apparatus #1. In other words, in a case of receiving the first identification information and/or the second identification information, terminal apparatus #2 may store (a) whether terminal apparatus #1 includes a UICC, and/or (b) whether terminal apparatus #1 is authorized to use the A2X communication via PC5 in a case that terminal apparatus #1 is “not served by E-UTRA”and/or “not served by NR”.

Terminal apparatus #2 may recognize (a) whether terminal apparatus #1 includes a UICC, and/or (b) whether terminal apparatus #1 is authorized to use the A2X communication via PC5 in a case that terminal apparatus #1 is “not served by E-UTRA” and/or “not served by NR”, based on the 20th identification information.

In a case that (a) terminal apparatus #1 does not include a UICC, and/or (b) terminal apparatus #1 is not authorized to use the A2X communication via PC5 in a case that terminal apparatus #1 is “not served by E-UTRA” and/or “not served by NR”, for terminal apparatus #1, terminal apparatus #2 need not perform a new PC5 unicast link establishment procedure, or need not perform the PC5 unicast link establishment procedure for DAA and/or DDAA and/or BRID.

Next, terminal apparatus #2 may transmit a second control message to terminal apparatus #1 (S2202). Terminal apparatus #2 may transmit the second control message including one or more pieces of identification information out of the 10th identification information to the 13th identification information to terminal apparatus #1.

Here, by transmitting one or more pieces of identification information out of the 10th identification information to the 13th identification information, terminal apparatus #2 may indicate the content indicated by each piece of identification information to terminal apparatus #1.

Specifically, by transmitting the 10th identification information, terminal apparatus #2 may indicate a cause value indicating #1 (direct communication to the target UE not allowed) to terminal apparatus #1. By transmitting the 10th identification information, terminal apparatus #2 may indicate that direct communication with terminal apparatus #2 is not allowed to terminal apparatus #1.

In a case that (a) terminal apparatus #2 does not include a UICC, and/or (b) terminal apparatus #2 is not authorized to use the A2X communication via PC5 in a case that terminal apparatus #2 is “not served by E-UTRA” and/or “not served by NR”, terminal apparatus #2 may transmit the 10th identification information and/or the 11th identification information, may include the 10th identification information and/or the 11th identification information in the second control message, or may transmit the second control message.

In a case that (a) terminal apparatus #2 does not include a UICC, and/or (b) terminal apparatus #2 does not include the 12th identification information and/or the 20th identification information, terminal apparatus #2 may transmit the 10th identification information and/or the 11th identification information, may include the 10th identification information and/or the 11th identification information in the second control message, or may transmit the second control message.

In a case that (a) terminal apparatus #2 does not include a UICC, and/or (b) terminal apparatus #2 includes the 12th identification information and/or the 20th identification information, terminal apparatus #2 may transmit the 10th identification information and/or the 11th identification information, may include the 10th identification information and/or the 11th identification information in the second control message, or may transmit the second control message.

Terminal apparatus #2 may determine whether to transmit the 10th identification information, or include the 10th identification information in the second control message, based on the first identification information and/or the second identification information. In a case that (a) terminal apparatus #1 does not include a UICC, and/or (b) terminal apparatus #1 is not authorized to use the A2X communication via PC5 in a case that terminal apparatus #1 is “not served by E-UTRA” and/or “not served by NR”, terminal apparatus #2 may transmit the 10th identification information and/or the 11th identification information, may include the 10th identification information and/or the 11th identification information in the second control message, or may transmit the second control message.

By transmitting the 11th identification information, terminal apparatus #2 may indicate that terminal apparatus #2 does not include a UICC to terminal apparatus #1. By transmitting the 11th identification information, terminal apparatus #2 may indicate that terminal apparatus #2 is not authorized to use the A2X communication via PC5 in a case that terminal apparatus #2 is “not served by E-UTRA”and/or “not served by NR”to terminal apparatus #1.

By transmitting the 11th identification information, terminal apparatus #2 may indicate that direct communication with terminal apparatus #2 is not allowed because (a) terminal apparatus #2 does not include a UICC and/or because (b) terminal apparatus #2 is not authorized to use the A2X communication via PC5 in a case that terminal apparatus #2 is “not served by E-UTRA” and/or “not served by NR”to terminal apparatus #1.

By transmitting the 12th identification information, terminal apparatus #2 may indicate whether terminal apparatus #2 is authorized to use the A2X communication via PC5 in a case that terminal apparatus #2 is “not served by E-UTRA” and/or “not served by NR” to terminal apparatus #1. By transmitting the 12th identification information, terminal apparatus #2 may indicate that terminal apparatus #2 is authorized or not authorized to use the A2X communication via PC5 in a case that terminal apparatus #2 is “not served by E-UTRA” and/or “not served by NR”to terminal apparatus #1.

By transmitting the 13th identification information, terminal apparatus #2 may indicate whether terminal apparatus #2 includes a UICC to terminal apparatus #1. By transmitting the 13th identification information, terminal apparatus #2 may indicate that terminal apparatus #2 includes or does not include a UICC to terminal apparatus #1.

Note that terminal apparatus #2 may determine whether or not to transmit the second control message and/or each piece of identification information, based on a state of terminal apparatus #2, and/or information received from the network, and/or the like.

Next, terminal apparatus #1 receives the second control message from terminal apparatus #2 (S2202). Terminal apparatus #1 may receive the second control message including one or more pieces of identification information out of the 10th identification information to the 13th identification information from terminal apparatus #2.

Furthermore, terminal apparatus #1 may recognize or store the received identification information, or may recognize determination of terminal apparatus #2, based on reception of the second control message. In a case of receiving the second control message, terminal apparatus #1 may perform the behavior in a case of receiving each piece of identification information.

Specifically, in a case of receiving the 10th identification information, terminal apparatus #1 may recognize a cause value indicating #1 (direct communication to the target UE not allowed). In a case of receiving the 10th identification information, terminal apparatus #1 may recognize that direct communication with terminal apparatus #2 is not allowed.

In a case of receiving the 11th identification information, terminal apparatus #1 may recognize that terminal apparatus #2 does not include a UICC. In a case of receiving the 11th identification information, terminal apparatus #1 may recognize that terminal apparatus #2 is not authorized to use the A2X communication via PC5 in a case that terminal apparatus #2 is “not served by E-UTRA”and/or “not served by NR”.

In a case of receiving the 11th identification information, terminal apparatus #1 may recognize that direct communication with terminal apparatus #2 is not allowed because (a) terminal apparatus #2 does not include a UICC and/or because (b) terminal apparatus #2 is not authorized to use the A2X communication via PC5 in a case that terminal apparatus #2 is “not served by E-UTRA”and/or “not served by NR”.

In a case of receiving the 10th identification information and/or the 11th identification information, terminal apparatus #1 need not attempt to initiate the PC5 unicast link establishment procedure for terminal apparatus #2. In a case of receiving the 10th identification information and/or the 11th identification information, terminal apparatus #1 need not attempt to initiate the PC5 unicast link establishment procedure for terminal apparatus #2 for at least time T.

In a case of receiving the 12th identification information, terminal apparatus #1 may recognize whether terminal apparatus #2 is authorized to use the A2X communication via PC5 in a case that terminal apparatus #2 is “not served by E-UTRA” and/or “not served by NR”. In a case of receiving the 12th identification information, terminal apparatus #1 may recognize that terminal apparatus #2 is authorized or not authorized to use the A2X communication via PC5 in a case that terminal apparatus #2 is “not served by E-UTRA”and/or “not served by NR”.

In a case of receiving the 13th identification information, terminal apparatus #1 may recognize whether terminal apparatus #2 includes a UICC. In a case of receiving the 13th identification information, terminal apparatus #1 may recognize that terminal apparatus #2 includes or does not include a UICC.

In a case of receiving the 12th identification information and/or the 13th identification information, terminal apparatus #1 may store a state of terminal apparatus #2 and/or information associated with terminal apparatus #2. In other words, in a case of receiving the 12th identification information and/or the 13th identification information, terminal apparatus #1 may store (a) whether terminal apparatus #2 includes a UICC, and/or (b) whether terminal apparatus #2 is authorized to use the A2X communication via PC5 in a case that terminal apparatus #2 is “not served by E-UTRA”and/or “not served by NR”.

In a case of receiving the 10th identification information and/or the 11th identification information, terminal apparatus #1 may delete the state of terminal apparatus #2 and/or the information associated with terminal apparatus #2. In other words, in a case of receiving the 10th identification information and/or the 11th identification information, terminal apparatus #1 may delete the information as to (a) whether terminal apparatus #2 includes a UICC, and/or (b) whether terminal apparatus #2 is authorized to use the A2X communication via PC5 in a case that terminal apparatus #2 is “not served by E-UTRA”and/or “not served by NR”.

In a case that (a) terminal apparatus #2 does not include a UICC, and/or (b) terminal apparatus #2 is not authorized to use the A2X communication via PC5 in a case that terminal apparatus #2 is “not served by E-UTRA” and/or “not served by NR”, for terminal apparatus #2, terminal apparatus #1 need not perform a new PC5 unicast link establishment procedure, or need not perform the PC5 unicast link establishment procedure for DAA and/or DDAA and/or BRID.

### 4.2. Second Embodiment

First, a second embodiment will be described. In the present section, the second embodiment may be referred to as the present embodiment.

In the present embodiment, the registration procedure, and/or the PDU session establishment procedure, and/or the network-requested UE policy management procedure, and/or the UE-requested A2X policy provisioning procedure, and/or the PC5 unicast link establishment procedure may be performed. Before the present embodiment, these procedures may be performed.

In the present embodiment, the A2X communication via PC5 in a broadcast mode may be performed. In the present embodiment, the A2X procedure may be performed. In the present embodiment, the A2X procedure for DAA and/or the A2X procedure for BRID may be performed. In the present embodiment, broadcast mode A2X communication over PC5 may be performed.

The terminal apparatus may store the 20th identification information. The terminal apparatus may be in a broadcast mode. The terminal apparatus may include the UE policy for BRID and/or DAA.

The behavior of the terminal apparatus according to the present embodiment will be described below.

The terminal apparatus may perform the A2X communication via PC5.

The terminal apparatus may include radio parameters.

Here, the radio parameters may be associated with a geographical area, and/or an altitude range, and/or a validity timer. The radio parameters may include the geographical area, and/or the altitude range, and/or the validity timer.

The radio parameters may be configured for each PC5 RAT (that is, LTE PC5, NR PC5).

In the present embodiment, the timer may be the validity timer, may be a timer using the validity timer, may be a timer using the radio parameter, may be a timer using the radio parameter associated with the validity timer, or may be a timer using the validity timer associated with the radio parameter. The validity timer may be interpreted as a timer.

In a case of being provided with the radio parameter, the terminal apparatus may start the validity timer, may start the timer by using the radio parameter associated with the validity timer, or may start the timer by using the validity timer.

In a case of being provided with the radio parameter, the terminal apparatus may start the validity timer, may start the timer by using the radio parameter associated with the validity timer, or may start the timer by using the validity timer.

In a case of starting the A2X communication, the terminal apparatus may start the validity timer, may start the timer by using the radio parameter associated with the validity timer, or may start the timer by using the validity timer.

In a case of starting the A2X communication, the terminal apparatus may start the validity timer, may start the timer by using the radio parameter associated with the validity timer, or may start the timer by using the validity timer.

Here, the validity timer or the radio parameter associated with the validity timer may be configured for each PC5 RAT (that is, LTE PC5, NR PC5). In a case that there are multiple validity timers or radio parameters associated with the validity timers configured for each PC5 RAT, the terminal apparatus may select or use the validity timer configured with a long time. For example, in a case that the validity timer configured for LTE PC5 is 10 seconds and the validity timer configured for NR PC5 is 50 seconds, the terminal apparatus may select or use the validity timer configured for NR PC5.

For each PC5 RAT, the terminal apparatus may start the validity timer, may start the timer by using the radio parameter associated with the validity timer, or may start the timer by using the validity timer. For example, in a case that the terminal apparatus receives the radio parameter in LTE, the terminal apparatus may select or use the validity timer configured for LTE PC5.

In a case that (a) the terminal apparatus starts the timer in a case of being provided with the radio parameter, and/or (b) the validity timer, or the timer using the validity timer, or the timer using the radio parameter associated with the validity timer expires, the terminal apparatus may select or use another validity timer configured for PC5 RAT different from the running timer configured for PC5 RAT. For example, in a case that the terminal apparatus starts the timer in a case of being provided with the radio parameter, and the timer using the validity timer configured for LTE PC5 expires, the terminal apparatus may start the timer by using the validity timer configured for NR PC5.

In a case that (a) the terminal apparatus starts the timer in a case of starting the A2X communication, and/or (b) the validity timer, or the timer using the validity timer, or the timer using the radio parameter associated with the validity timer expires, the terminal apparatus need not select or use another validity timer configured for PC5 RAT different from the running timer configured for PC5 RAT. For example, in a case that the terminal apparatus starts the timer in a case of starting the A2X communication, and the timer using the validity timer configured for LTE PC5 expires, the terminal apparatus need not start the timer by using the validity timer configured for NR PC5.

In a case that the terminal apparatus performs the A2X communication over PC5 by using the radio parameter associated with the geographical area and/or the altitude range and exits from the geographical area and/or the altitude range, the terminal apparatus may stop the A2X communication over PC5, or may stop the validity timer.

Furthermore, in a case that the terminal apparatus is “not served by NR” and “not served by E-UTRA” for the A2X communication via PC5, and/or the terminal apparatus is to use radio resources other than those operated by the serving cell for the A2X communication over PC5, the terminal apparatus may select an appropriate radio parameter for a new geographical area.

Furthermore, in a case that the terminal apparatus is “served by NR” and/or “served by E-UTRA” for the A2X communication over PC5, and/or the terminal apparatus is to use radio resources for the A2X communication over PC5 operated by the serving cell, the terminal apparatus may perform a procedure for starting the A2X communication over PC5 in a case of being “served by NR”and/or “served by E-UTRA”over PC5.

In a case that the terminal apparatus performs the A2X communication over PC5 by using the radio parameter associated with the validity timer, and the validity timer expires, the terminal apparatus may stop the A2X communication over PC5, or may perform a procedure for starting the A2X communication on Uu.

Furthermore, in a case that the terminal apparatus is “not served by NR” and “not served by E-UTRA” for the A2X communication via PC5, and/or the terminal apparatus is to use radio resources other than those operated by the serving cell for the A2X communication over PC5, the terminal apparatus may select an appropriate radio parameter for a new geographical area.

Furthermore, in a case that the terminal apparatus is “served by NR” and/or “served by E-UTRA” for the A2X communication over PC5, and/or the terminal apparatus is to use radio resources for the A2X communication over PC5 operated by the serving cell, the terminal apparatus may perform a procedure for starting the A2X communication over PC5 in a case of being “served by NR” and/or “served by E-UTRA” over PC5, or may perform a procedure for starting the A2X communication on Uu.

In a case that the terminal apparatus performs the A2X communication over PC5 by using the radio parameter associated with the validity timer, and the validity timer expires, the terminal apparatus may request a new validity timer or radio parameter from the 5G AN (or the gNB) and/or the network.

The terminal apparatus performs the A2X communication over PC5 by using the radio parameter associated with the validity timer, and before the validity timer expires, the terminal apparatus may request a new validity timer or radio parameter from the 5G AN (or the gNB) and/or the network.

In a case that the terminal apparatus performs the A2X communication over PC5 by using the radio parameter associated with the validity timer, and the validity timer expires, the terminal apparatus may update the validity timer or the radio parameter.

The terminal apparatus performs the A2X communication over PC5 by using the radio parameter associated with the validity timer, and before the validity timer expires, the terminal apparatus may update the validity timer or the radio parameter.

In a case of receiving a new validity timer or radio parameter from the 5G AN (or the gNB) and/or the network, the terminal apparatus may stop the running timer, may start the timer using the received validity timer, or may start the timer using the received radio parameter.

In a case of an emergency call or an emergency service, the terminal apparatus may stop the running timer, or may stop the A2X communication. In a case of an emergency call or an emergency service, the terminal apparatus may request the validity timer or the radio parameter from the network, or may update the validity timer or the radio parameter.

In a case of an emergency call or an emergency service, and even in a case that the timer has already expired, the terminal apparatus may start the A2X communication by using the radio parameter associated with the timer.

### 5. Modifications

A program running on an apparatus according to the present example may serve as a program that controls a Central Processing Unit (CPU) and the like to cause a computer to function to realize the functions of the aforementioned embodiments according to the present example. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing the functions of the embodiments according to the present example may be recorded on a computer-readable recording medium. The functions may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be a semiconductor recording medium, an optical recording medium, a magnetic recording medium, a medium dynamically retaining the program for a short time, or any other computer-readable recording medium.

Each functional block or various features of the apparatuses used in the aforementioned embodiments may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. Furthermore, in a case that with advances in semiconductor technology, a circuit integration technology appears that replaces the present integrated circuits, the present example can also use a new integrated circuit based on the technology.

Note that the present example is not limited to the above-described embodiments. Although apparatuses have been described as an example in the embodiments, the present example is not limited to these apparatuses, and is applicable to a terminal apparatus or a communication apparatus of a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present example have been described in detail above referring to the drawings, the specific configuration is not limited to the embodiments and includes, for example, design changes within the scope that do not depart from the gist of the present example. Furthermore, various modifications are possible within the scope of the present example defined by claims, and embodiments that are made by suitably combining technical means disclosed according to the different embodiments are also included in the technical scope of the present example. A configuration in which elements described in the respective embodiments and having mutually similar effects are substituted for one another is also included.

### INDUSTRIAL APPLICABILITY

The present example can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 Mobile communication system
10 UE_A
30 PGW-U
32 PGW-C
35 SGW
40 MME
45 eNB
50 HSS
60 PCRF
80 Access network_A (E-UTRAN)
90 Core network A
120 Access network_B (5G AN)
122 gNB
130 UPF
132 SMF
140 AMF
150 UDM
160 PCF
190 Core network_B
235 UPF_A
239 UPF C

1. (canceled)

2. User Equipment (UE) comprising:
control circuitry, wherein
the UE is an Uncrewed Aerial Vehicle (UAV), and
the control circuitry is configured to, in a case that the UE is performing Aircraft-to-anything (A2X) communication over PC5 by using a radio parameter associated with an altitude range and the UE moves out of the altitude range, stop the A2X communication over the PC5.

3. The UE according to claim 2, wherein
the control circuitry is further configured to, in a case that the UE is performing the A2X communication over the PC5 by using a radio parameter associated with an geographical area and the UE moves out of the geographical area, stop the A2X communication over the PC5.

4. The UE according claim 2, wherein
the radio parameter is pre-configured in the UE.

5. The UE according claim 2, wherein the radio parameter is provided by a core network.

6. A method performed by User Equipment (UE),
the UE being an Uncrewed Aerial Vehicle (UAV),
the method comprising:
in a case that the UE is performing Aircraft-to-anything (A2X) communication over PC5 by using a radio parameter associated with an altitude range and the UE moves out of the altitude range, stopping the A2X communication over the PC5.
